(19) United States
(12) Patent Application Publication
(10) Pub. No.: US 2004/0242108 A1
(43) Pub. Date: Dec. 2, 2004

(54) Fabrics composed of waste materials

(76) Inventors: Stephen J. Russell, North Yorkshire (GB); Ali Pourmohammadi, Leeds West Yorkshire (GB)

Correspondence Address: MYERS BIGEL SIBLEY & SAJOVEC, PO BOX 37428, RALEIGH, NC, 27627, US

(21) Appl. No.: 10/481,656

(22) PCT Filed: Dec. 21, 2002
(86) PCT No.: PCT/GB02/02862

(30) Foreign Application Priority Data
Jun. 22, 2001 (GB) 0115276.8

(51) Int. Cl. B32B 27/04; B32B 5/02; B32B 17/02; D04H 1/00; B32B 5/16

(52) U.S. Cl. 442/414; 442/417; 442/415; 442/376; 442/97; 442/172

(57) ABSTRACT

A nonwoven fabric includes fibres such that a proportion of the fibres have a length of from about 0.1 to 1.5 mm. The fibres may be homogenous, heterogeneous, and/or mixed waste materials of small particle size and the proportion of binder present is about 15% w/w or less. Processes for manufacturing such a nonwoven fabric and uses of such fabric are also described.

This invention relates to a novel form of nonwoven fabric, to methods of preparation of such fabrics and to products comprising such fabrics.

U.S. Pat. No. 3,671,615 describes a method of making a composite board product which comprises the use of chopped scrap materials, e.g. chopped to 1/32 inch (0.79 mm). However, the board product also comprises from 40 to 80% w/w of plastic materials and from 10 to 40% of a filler material.

The use of such plastics and filler materials may be undesirable for a number of reasons. One particular disadvantage is that the use of plastics and fillers makes it difficult to produce nonwoven fabrics with good thermal stability.

U.S. Pat. No. 6,037,282 to Milding et al, describes a nonwoven material produced by hydroentangling a fibre web comprising fibres with a length of between 5 and 60 mm. Although Milding appears to suggest that very low amounts of binder may be used, e.g. 0.1 to 10% w/w, in the only example provided by Milding, the nonwoven material comprised 60% coniferous pulp and 40% synthetic fibres, the synthetic fibres being made up of polypropylene (PP) and/or polyethyleneterephthalate (PET). Clearly, such synthetic fibres are relatively low melting and therefore in any process which comprises heating the nonwoven material, the synthetic fibres are likely to act as a binding agent.

We have now surprisingly found a process by which novel nonwoven fabrics may be prepared. Such novel fabrics may truly have low amounts of binder present, or may optionally be prepared with substantially no binder. Furthermore, the nonwoven fabrics may comprise, if desirable, fibres of much shorter length than those of the prior art, namely, less than 5 mm.

Thus, according to the invention we provide a nonwoven fabric in which a substantial proportion of the fibres* have a length of from 0.1 to 12 mm and the proportion of binder present is 15% w/w or less.

In a preferred embodiment of the invention the nonwoven fabric comprises a substantial proportion of fibres with a length of less than 5 mm, preferably from 0.1 to less than 5 mm, more preferably 0.1 to 3 mm. In a further embodiment, the nonwoven fabric may comprise a mixture of fibre lengths in which from 5 to 100% w/w of the fibres has a length of from 0.1 to less than 5 mm, more preferably, from 20 to 80% w/w of the fibres has a length of from 0.1 to less than 5 mm. In a yet further embodiment from 40 to 70% w/w of the fibres have a length of from 0.1 to 3 mm.

In a further embodiment of the invention the proportion of the binder may be from 0 to 15% w/w, more preferably 0 to 10% w/w.

In a yet further feature of the invention the nonwoven fabric may be substantially free of binder. Indeed, it is a particular advantage of the present invention that certain high performance fibres may be produced into nonwoven materials, which are substantially free of binder. Examples of such high performance fibres are the aramids, e.g. Kevlar®, metal fibres, e.g. aluminium fibres, carbon fibres and others such as glass fibres, etc.

Examples of fibres which may be used in the nonwoven fabrics of the invention include, but are not limited to, natural fibres such as pulp fibres, cotton, jute, wool and hair fibres etc., synthetic staple fibres, e.g. polyester, viscose rayon, nylon, polypropylene and the like, pulp fibres or mixtures of pulp fibres and staple fibres, aramid fibres, e.g. Kevlar®, metal fibres, e.g. aluminium fibres, carbon fibres; and mixtures of any of the abovementioned.

Thus according to a particular feature of the invention we provide a nonwoven fabric as hereinbefore described wherein a substantial proportion of the fibres may be Aramid (e.g. Kevlar®) fibres. In such nonwoven fabrics the amount of aramid fibres may be up to 100% w/w.

Certain aramid fibres, such as Kevlar® are particularly advantageous in that they possess good thermal stability. Thus, in a further feature of the invention we provide a nonwoven aramid fabric as hereinbefore described which is substantially free of binder.

When such fabrics are described as being substantially free of binder, this is intended to include such fabrics as being substantially free of synthetic, low melting point fibres.

In an especially preferred embodiment of the invention we provide a nonwoven fabric as hereinbefore described wherein the fabric is mixed with one or more other heterogeneous fibrous particles e.g. entangled fibre entities, fibre pieces, yarn segments, non-textile materials (e.g. ceramic particles, metal fragments) and/or dust.

It is yet a further feature of the invention that the nonwoven fabrics may comprise a proportion of particles enmeshed within the fibres. Such particles may be fabric particles, for example, from waste sources, or metallic particles. When the particles comprise one or more metals, the nonwoven fabrics may be suitable for, inter alia, use in the manufacture of abrasive cloths. It is a particular advantage of the present invention that such fabrics with enmeshed particles may be manufactured without the need for thermoplastic, e.g. synthetic or natural binders, or latex binders. Conventionally known abrasive nonwoven fabrics include such thermoplastic or latex binders and are therefore hindered in their utility at high temperatures. Therefore, with the nonwoven fabrics of the present invention, materials such as Kevlar®, can be used to manufacture thermally resistant nonwoven abrasive fabrics.

Alternatively such particles may comprise odour control agents.

Thus according to a yet further feature of the invention we provide a thermally stable nonwoven fabric as hereinbefore described, which is provided with enmeshed metallic particles.

When the particles comprise odour control agents, different classes of odour-control agents are known in the art according to their different mechanisms of action. Disposable absorbent articles can comprise only one odour-control agent, or combinations of various odour-control agents, optionally belonging to different classes and therefore performing different actions for the control of unpleasant odours.

A first class of odour-control agents is constituted by those compounds that interfere with the bacterial metabolism, in order to avoid or to reduce, for example, the production of malodorous metabolites from the body fluids; such agents can be bactericides or bacteriostats and are typically available as water-soluble compounds.

A second class of odour-control agents comprises those compounds, typically in particulate form, that are capable of adsorbing within their structure the odoriferous substances, both those already present in the body fluids as such and those produced by the bacterial metabolism.

Another class of odour-control agents comprises perfumes that essentially mask the unpleasant odours; moisture-activated encapsulated perfume particles can also be used.

Suitable odour-control agents that can be employed in the practice of the present invention can be for example water-soluble antibacterial compounds. Such compounds include, for example, halogenated phenylene compounds (U.S. Pat. No. 3,093,546), periodic acids (U.S. Pat. No. 3,804,094), various copper compounds, especially copper acetate (U.S. Pat. No. 4,385,632), various quaternary ammonium salts, which are well known for their antibacterial properties, e.g. cetyl pyridinium chloride, and the like. Alternatively, antibacterial compounds can be used conjointly with various particulate materials, which, in use and in the presence of moisture, release the antibacterial agent. Zeolite materials, such as zeolites, which are bactericidal by virtue of having absorbed therein and thereon various bacterial cations such as copper, silver and zinc, can be advantageously used in the practice of this invention (U.S. Pat. No. 4,525,410).

In a preferred mode, the odour control agent is a water-insoluble particulate odour absorbing material such as chlorophyl particles, activated carbon granules, charcoal, ion exchange resin (Japanese Patent No. 87019865), activated alumina, and absorbent zeolite materials, including the well known “molecular sieve” zeolites of the type A and X and the zeolite materials marketed under the trade name ABSENTS by the Union Carbide Corporation and UOP, and which are typically available as a white powder in the 3-5 micron particle size range.

The odour-control agents used in the present invention can also comprise other compounds such as cyclodextrin, chelating agents, parabens, chitin, pH buttered materials, silica gel, clays, diatomaceous earth, polystyrene derivatives, starches, and the like. For example, chelating agents as those described in European Patent applications Nos. EP 96109178.2 and EP 96109179.0, both applications filed on 7 Jun. 1996, are particularly preferred. Some partially neutralised hydrogen forming absorbent gelling materials, such as polyacrylate gelling material and acrylate grafted starch gelling material can be also be used, preferably in combination with other odour-control agents.

Further odour control agents can comprise acidic compounds such as ascorbic acid, stearic acid, boric acid, maleic acid polymers, malonic acid, maleic acid, polyacrylic acid and monopotassium phosphate, or basic compounds such as inorganic salts of carbonates, bicarbonate, phosphate, biphosphate, sulfate, bisulfate, borate, and mixtures thereof, as those described in U.S. Pat. No. 5,037,412, or as the combination of boric acid and sodium tetraborate described in International Patent application WO 94/25077.

In a yet further aspect of the invention the fabric of the invention may be suitable as a filter material, e.g. a gas or liquid, such as an air or water filter. It is a particularly advantageous aspect of the invention that fabrics with improved engineering of the pore size distribution may be obtained for such applications. Thus, in one embodiment, the pore size distribution may be such that it is substantially uniform, see FIG. 2. For some filter applications, 100% of the pores lie within a range of from 10 to 50 μm diameter, more preferably from 40 to 50 μm. In the novel filter of the invention nonwoven fabric may comprise a variety of materials including blends.

In a further aspect of this embodiment of the invention the fabric may include particles as hereinbefore described which may act, for example, as a chemical filter. Such particles may, for example, comprise activated charcoal and/or other chemical filters/adherents that are conventionally known per se. Such particles may comprise, for example, an activated carbon. The size of the particles may vary according to, inter alia, the nature of the filter, the type of material to be removed by the filter, etc. By way of example only the particles may have a mean particle diameter in the range of from about 50 microns to about 250 microns. Alternatively, an example of particles may comprise silicon and/or manganese dioxide particles. It will be understood by one skilled in the art that a wide variety of other particles conventionally known to be useful as a filter medium may be included in the non woven fabric of the invention.

In an alternative aspect of the invention the fabric may be suitable for use in horticulture, agriculture and/or aquaculture. For example, in horticulture and/or agriculture, the fabric may be impregnated with plant seeds and/or plant nutrients, fungicides, etc. Thus, the fabric may provide a means of delivering seed which are readily wettable in the form of a plant germination mat wherein a plurality of seeds may be situated on or incorporated into the mat. Thus, for example, such a mat may be stored dry and in use is cut to a desired shape and spread over the land and watered. Such a mat is advantageous in that, inter alia, the mat may be laid in any desirable pattern. Furthermore, the mat may act as a mulch, suppressing weeds and degrading over time. A variety of seeds may be employed, including flowering plant seeds, vegetable seeds and/or grass seeds or any combination thereof. Furthermore a fertiliser may also be incorporated into the mat.

Thus we also provide a method of growing plants comprising the steps of placing an appropriate plant seed germination mat on the soil and watering.

In aquaculture the fabric of the invention may similarly be impregnated with plant seeds and/or plant nutrients. However, in addition, the fabric may be impregnated with, for example, eggs of aquatic animals, e.g. freeze dried eggs. Thus, a suitably impregnated fabric may be able to act as a “pond-in-a-bag”.

Similarly, in aquaculture, the fabric may act as a chemical filter suitable for use in fish farming, e.g. enable waste deposits and/or chemicals to be removed from the sea/river bed.

In the horticultural/aquacultural embodiments of the invention it is especially advantageous that the fabric of the invention may be biodegradable. Thus, by way of example only, the fabric may be selected to comprise one or more of jute, flax, hemp, cotton, wool, etc. or any conventionally known biodegradable fibres

In a yet further embodiment of the invention the fabric may be suitable for the slow or sustained release of one or more medicaments. Thus, the fabric may be suitable for use as, e.g. an absorbent article, such as a wound dressing or other such articles.

In a further alternative, the fabric may be adapted to be a cleansing article, such as a wipe, pad or mop, etc. Thus, the fabric may be impregnated with one or more of a detergent, bleach or wax, etc., such as is conventionally known in the art. One example of such a cleansing article is described in International Patent application No. WO 01/22860, which is incorporated herein by reference. Thus, for example, the wide range of cleansing materials described in may also be incorporated in the fabric of the present invention.

Therefore according a to a further aspect of the invention we provide a method of cleaning a surface which comprises the use of a cleansing article as hereinbefore described.

The fabric structures produced are characterised by a random fibre orientation in which fibres are arranged in three dimensions. The fabric weight may be in the range 20-1000 g/m² and the fabric density may be as low as 0.02 g/cm³.

According to a further feature of the invention, we provide a process for the preparation of a nonwoven fabric according to claim 1, which comprises mixing 0-15% w/w of thermoplastic fibres with waste materials.

The web structure may be consolidated using thermal, mechanical or a combination of both bonding methods. Thermal bonding is obtained by mixing bicomponent or homogeneous thermoplastic fibres or particles with waste materials, typically in the proportion 5-50% (by weight of fibre) and then using either contact or through air bonding devices. Mechanical bonding can be applied using hydroentanglement. The use of a hydroentanglement system is preferred.

Composite structures can also be produced by layering single layers (which can be formed from different fibre types and specifications), and then bonding them together using either thermal or mechanical bonding methods. This results in a composite structure with different characteristics in the face and back of the fabric. The final product can be used in a wide range of applications such as insulation (sound and heat), automotive industry (hard press parts for floor, side seat linings, boot compartment, battery separator), furniture industry (wadding material, mattress web) and many others.

The nonwoven fabric of the invention may be a flexible or rigid (i.e. board-like) nonwoven fabric and may comprise of carpet waste compounds, for example, of mainly dust and cropped fibres from 0.1-12 mm length of different fineness. Webs may be formed using a sifting air-lay system (of the type described in U.S. Pat. No. 4,014,635) where the processability of the waste materials can be improved by altering/adjusting the machine settings accordingly/appropriately. In one embodiment, the machine may employ a sifting mechanism in which, for example, carpet waste materials are dispersed by rotor blades and are drawn by suction through a mesh screen (top grid) and finally deposited on the surface of a moving conveyor belt. The dispersion of the fibres in the airflow provides the opportunity for randomisation of the fibre arrangement in the landing area on the belt and allows formation of high loft materials/bulky structures with low density. The fibres are circulated using rotating blades through the dispersing zone of the machine. Each pair of blades has a rapid rotational motion (of Ca. 1240 rpm) around their axes and a slower rotational motion (Ca. 300 rpm) around a fixed axis situated vertically at either side of the machine's centre. Owing to the suction, the fibres pass through the top grid towards the moving conveyor belt where they finally land and form a web.

The web structure may be consolidated using thermal, chemical, and mechanical means or a combination of these methods. Thermal bonding is obtained by mixing bicomponent or homogeneous thermoplastic fibres or particles with waste materials, typically in the proportion of 5-50% (by weight of fibre) and then using either contact or through air bonding devices. Mechanical bonding can also be applied using hydroentanglement.

It should be noted that although the term “fibre” is often defined as having a length to diameter ratio of >100, the description herein includes such materials but the “fibre” should be construed as including a wider ratio.

The process and the novel nonwoven fabric of the invention is advantageous in that, inter alia, it comprises a more environmentally acceptable process (since binder is not an essential part of the structure).

The nonwoven fabric can be a flexible product or a solid panel or board (as opposed to the moulded panel products obtained using U.S. Pat. Nos. 5,626,939 and 5,662,994).

There is no need for cleaning and sorting the waste materials prior to the procedure.

Waste fibres, dust and particles in a range of 0.1-12 mm length can be recovered (against the U.S. Pat. No. 6,037,282).

The process is not expensive and is commercially viable. Air laying technology has already been used in the textile industry for many years.

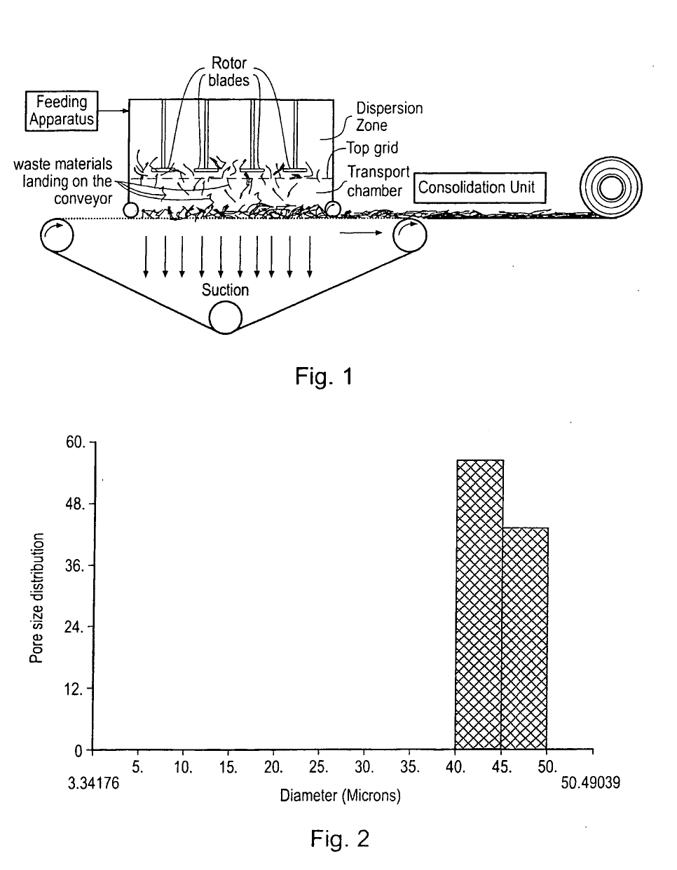

The invention will now be illustrated by way of example only and with reference to the accompanying drawing, in which FIG. 1 is a schematic representation of a typical fabric formation process.

Referring to FIG. 1, the waste materials (including fibres, particles and/or dry powders) are fed to the web formation process and then the formed web is consolidated using thermal, chemical or mechanical bonding where finally the integrated web is wound up.

### EXAMPLE 1

A web structure was produced using a sifling-air-laid system from a fibre blend of 70% carpet crop waste (i.e. mainly dust with 80% of fibres with a length of <2 mm) and 30% bicomponent low melting point 1.7 dtex, 6 mm fibre length.

The waste carpet material consisted of a mixture of short fibres, entangled entities (nep-like entanglements) and particles. The bonding fibres are PE/PP sheath-core bicomponents (1.7 dtex, 6 mm length) with a melting temperature of 135° C. The bonding fibres and waste materials are premixed in the weight ratio of 30:70, respectively. The blend was fed to an air-lay machine of the type (U.S. Pat. No. 4,014,635) operating with the settings summarised in Table 1.

TABLE 1
Summary of processing conditions used in Example 1

| | |
|---|---|
| Rotating blade speed | 1240 (rev/min) |
| Blade size | 2 cm × 10 cm |
| Top grid dimensions | Mesh aperture size 1.8 mm (square sett) |
| | Wire diameter 0.3 mm |
| Conveyor belt dimensions | Mesh aperture size 0.2 mm × 0.4 mm |
| | Wire diameter 0.23 mm |
| Conveyor linear speed | 10 cm/min |
| Air to fibre ratio | 1.82 (m³ of air/gr. of fibre) |

The web was then consolidated using through air bonding at 140° C. for 30 mins. The dimensional properties of the final products are given below.

| Weight (g/m²) | Thickness (mm) | Density (g/cm³) |
|---|---|---|
| 220 | 3.83 | 0.06 |

The product was satisfactory for use as an insulation material (sound or heat insulation).

### EXAMPLE 2

In this example, the same procedure (i.e. using the same web formation and consolidation method) was followed as in Example 1 except, with a fibre blend percentage of 85% carpet waste (supplied by a different manufacturer but with the sample specifications as in Example 1) and 15% bicomponent fibres. A range of different fabric weights was produced as shown in Table 2.

TABLE 2
Dimensional properties of samples made from carpet waste using
Example 2.

| Weight (g/m²) | Thickness (mm) | Density (g/cm³) |
|---|---|---|
| 180 | 5.1 | 0.035 |
| 205 | 5.5 | 0.037 |
| 300 | 6.6 | 0.045 |
| 750 | 7.5 | 0.1 |

### EXAMPLE 3

In this example again the same procedure was followed as in example 2, except that the thermally bonded web was needle-punched to produce a more flexible and denser structure. The needling machine used was fitted with a single-needle board and 36 gauge needles. A needle punch density of 16 p/in² was used. The needle penetration was 12 mm. The dimensional properties of this sample are shown below.

| Weight (g/m²) | Thickness (mm) | Density (g/cm³) |
|---|---|---|
| 230 | 3.3 | 0.07 |

### EXAMPLE 4

This sample was produced from 100% waste materials (mainly in the form of small broken-up fabric particles). Web formation was carried out using the same air-laying system as in Example 1. The top grid was replaced with a grid of 4 mm×4 mm aperture size. The produced web was then hydroentangled to consolidate the structure. No binder is used. The final product exhibited acceptable mechanical and physical properties such as strength, extensibility and air permeability, see Table 3

TABLE 3
Mechanical and physical properties of 100% waste
sample produced by the method used in Example 4

| | |
|---|---|
| Weight (g/m²) | 240 |
| Thickness (mm) | 2.02 |
| Density (g/m³) | 0.12 |
| Air permeability (cm³ · cm² | |
| at 1 cm of water) | 21 |
| Breaking load (N) | 4.0 |
| Extension (%) | 18 |

### EXAMPLE 5

Samples were produced from waste Aramid fibres (Kevlar®) with variable dimensions. The fibres were processed in the same air-laying system as in example 1. Also a sample made of 70% Kevlar® waste and 30% lyocell was produced. Both fibres were characterised by wide variation in fibre length and fibre entanglement. The webs were consolidated using hydroentanglement. Table 4 shows the physical properties of the samples.

| | | | | Strength | Extension |
|---|---|---|---|---|---|
| | Weight | Thickness | Density | (MD) | (MD) |
| Sample | (g/m²) | (mm) | (g/m³) | (N) | (%) |
| Kevlar 1 | 120 | 3.0 | 0.04 | 3.4 | 10.3 |
| Kevlar 2 | 75 | 2.2 | 0.034 | 1.3 | 14.5 |
| Kevlar/Lyocell | 90 | 1.9 | 0.047 | 2.1 | 11.1 |

### EXAMPLE 6

### Abrasive Fabrics

Material containing recovered synthetic fibre waste of variable lengths (0.5 mm-12 mm) and linear density (up to 300 dtex), abrasive particles and broken-up binder particles (dust) was obtained by mechanical shredding of industrial abrasive fabrics. Such waste abrasive fabric is available in the form of roll ends, edge cuttings and other cutting waste and is produced as part of normal abrasive fabric manufacture. Alternatively, similar mixed waste can be obtained direct from other stages of the manufacturing process. The mixed, unsorted waste material was directly fed in to the air-laying unit and continuously formed in to a uniform web. Subsequently, the web was chemically bonded with a cross-linking binder using a spray application method. The resulting fabric containing the waste material was suitable for use as an abrasive article (e.g. a scouring pad or similar application). To increase the abrasive properties of the fabric, additional abrasive particles could be introduced to the waste fibre mixture during either web formation or during the latex binder application stage.

### Filter Fabrics

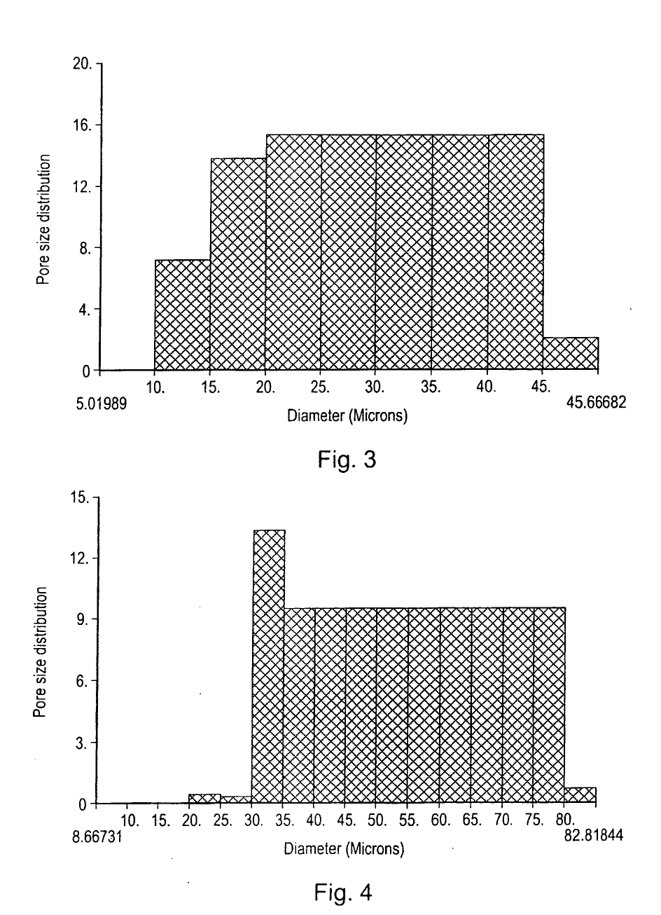

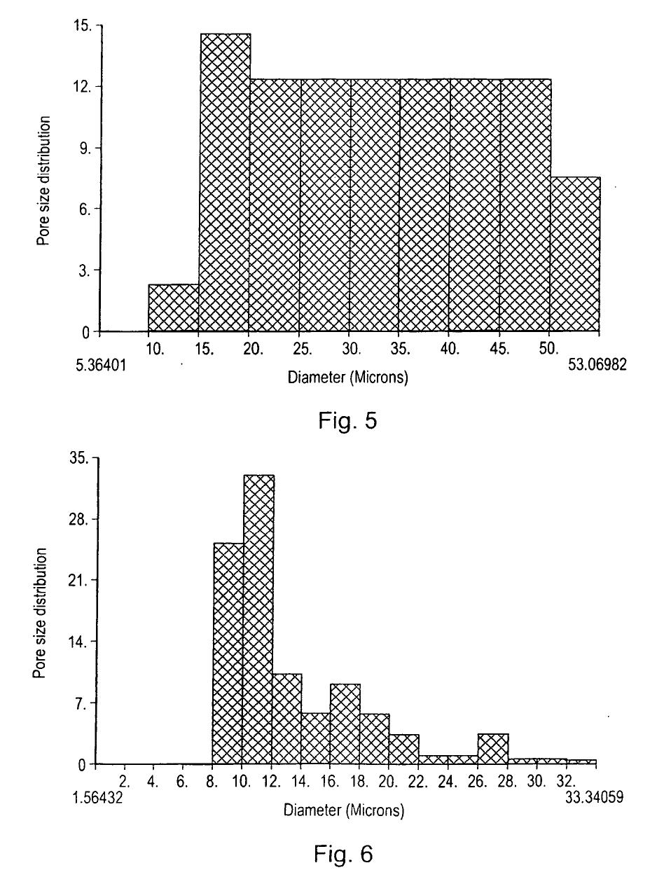

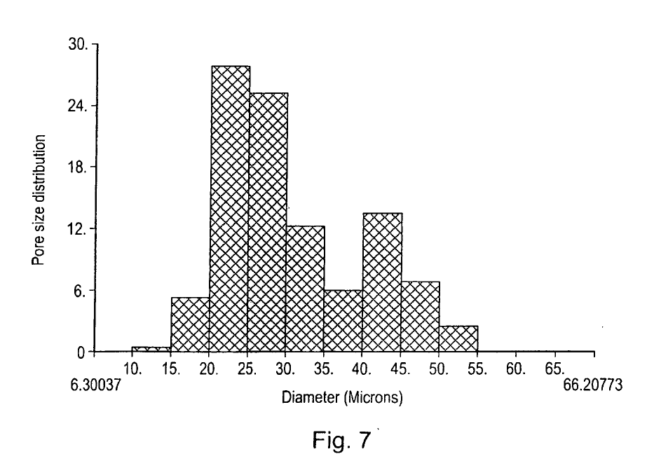

Filtration media (dry and liquid) were formed direct from short mixed fibre waste containing fibre particles, yarn pieces and 10% of bicomponent fibres. The unsorted mixed waste was fed directly to the air-lay unit and formed in to webs that were subsequently bonded using heated calender rollers. The thickness of the fabrics ranged from 0.85 mm-6 mm. Using a PMI porometer (a porometer is an instrument that measures the diameter of a pore at its most constricted part, the largest pore diameter, the mean pore diameter, and the pore distribution in a porous material The measurements are based on the flow of an inert gas through dry and wet samples of the porous material. The pores in the sample are spontaneously filled with a liquid. Gas pressure on one side of the sample is slowly increased to remove liquid from pores and permit gas flow through the pores. Measured differential pressure and flow rates of gas through wet and dry samples are used to compute pore characteristics). The permeability and pore size distributions of the samples were obtained (see Table 4 and FIGS. 2 to 7).

TABLE 4
Specifications of samples produced using waste materials

| | Thickness | Average Darcy's | Weight per | Density |
|---|---|---|---|---|
| Samples | (mm) | permeability const. | unit area (g/m²) | (g/cm³) |
| 1 | 3.2 | 29.54 | 410 | 0.128 |
| 2 | 3.4 | 49.00 | 315 | 0.093 |
| 3 | 0.85 | 40.00 | 95 | 0.112 |
| 4 | 2.2 | 31.36 | 400 | 0.182 |
| 5 | 2.6 | 8.75 | 760 | 0.292 |
| 6 | 3.1 | 260.23 | 365 | 0.118 |

FIGS. 2 to 7 are pore size distributions of typical fabric samples (samples 1 to 6 respectively) made from mixed waste materials

In general compared to existing commercial filter media (e.g. nonwovens made from staple fibres and foam-based structures) it is possible to achieve:

1) Narrower pore size distributions i.e. smaller range of pore sizes within the fabric (for example see FIG. 2 sample 1).

2) Engineering of different pore size distributions from the same waste material (e.g. normal, skewed, multi-modal (flat-topped distributions). (for example see FIGS. 2 to 7, samples 1-6)

In these samples a minimum pore size of 8 microns was achieved.

### Fabric Structure

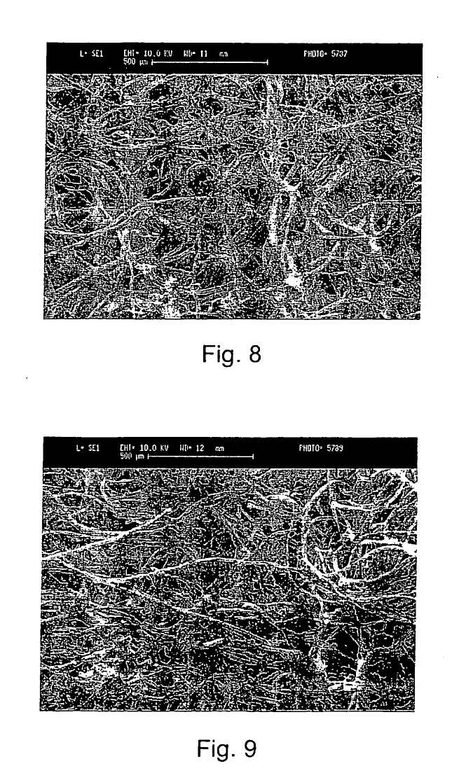

The use of unsorted mixed waste containing a mixture of short variable length fibres, particles, dust, thread waste or non-textile materials (e.g. ceramic particles, metal fragments, feathers etc) as well as polymeric waste yields three-dimensional fabric structures with novel compositions and architectures. Scanning electron microscopy was used to obtain images of the internal structure of such fabrics. Examples of typical images are shown in FIGS. 8 to 11:

FIG. 8 is an SEM of sample 2

FIG. 9 is an SEM of sample 1

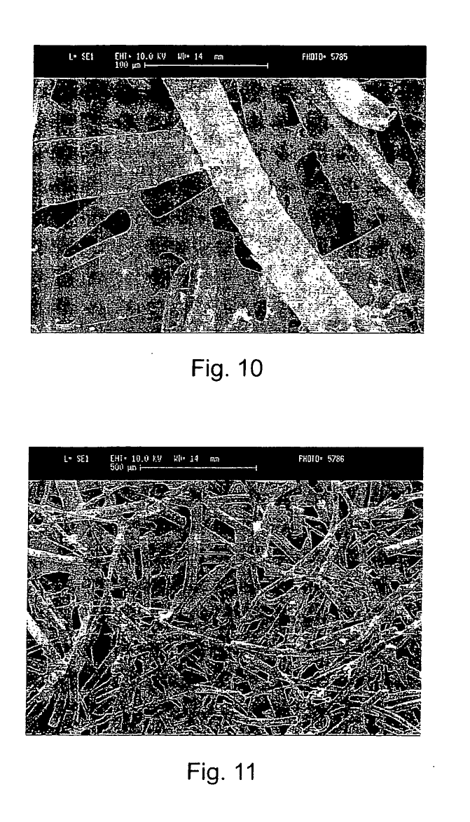

FIG. 10 is a close-up SEM of sample 3

FIG. 11 is an SEM of sample 3

The fabrics shown (samples 1-3) were produced from broken-up clothing waste (fabric pieces) and carpet waste, which was too short to be used in conventional recycling processes. The waste contained a mixed composition of short fibre, dust, yarn threads, hair, feathers and some metal particles. A bicomponent fibre (10% owf) was added prior to web formation to act as a binder. Typical SEM images of the resulting structures after calender bonding are shown in Figure (8-11). The complex fibre network and fine pore structure resulting from the consolidation of the many fine particles and short waste fibres can be appreciated from the SEM images.

1. A nonwoven fabric, comprising:
fibres in which at least a portion of the fibres have a length from about 0.1 to 1.5 mm; and
binder for the fibres at a proportion of about 15% w/w or less.

2. A nonwoven fabric according to claim 1 wherein the fibres comprise a mixture of fibre lengths in which from about 5 to 100% w/w of the fibres have a length of from about 0.1 to 5 mm.

3. A nonwoven fabric according to claim 2 wherein the fibres comprise a mixture of fibre lengths in which from about 40 to 70% w/w of the fibres have a length of from about 0.1 to 3 mm.

4. A nonwoven fabric according to claim 1 wherein the proportion of the binder present is from 0 to 15% w/w.

5. A nonwoven fabric according to claim 1 wherein the proportion of the binder present is from 0 to 10% w/w.

6. A nonwoven fabric according to claim 1 wherein the nonwoven fabric is substantially free of binding agent the binder.

7. A nonwoven fabric according to claim 1 wherein at least a portion of the fibres are high performance fibres selected from aramids, glass, metal, carbon fibres, and/or alginates.

8. A nonwoven fabric according to claim 1 wherein at least a portion of the fibres are Aramid fibres.

9. A nonwoven fabric according to claim 8 wherein the nonwoven fabric comprises up to 100% w/w of Aramid fibres.

10. A nonwoven fabric according to claim 1 wherein the nonwoven fabric is substantially free of binder and a substantial proportion at least a portion of the fibres are high performance fibres.

11. A nonwoven fabric according to claim 1 wherein the nonwoven fabric mixed with one or more further comprises a mixture of at least one other heterogeneous fibrous particles particle.

12. A nonwoven fabric according to claim 11 wherein the at least one other heterogeneous fibrous particle is selected from entangled fibre entities, fibre pieces, yarn segments, non-textile materials and/or dust.

13. A nonwoven fabric according to claim 12 wherein the non-textile materials are selected from ceramic particles and metal fragments.

14. A nonwoven fabric according to claim 1 wherein the nonwoven fabric further comprises a proportion of particles enmeshed within the fibres.

15. A nonwoven fabric according to claim 14 wherein the particles are fibre and/or fabric particles.

16. A nonwoven fabric according to claim 14 wherein the particles comprise an odour control agent.

17. A nonwoven fabric according to claim 14 wherein the particles are metallic particles.

18. A nonwoven fabric according to claim 17 wherein the nonwoven fabric is made up into an abrasive cloth.

19. A nonwoven fabric according to claim 14 wherein the nonwoven fabric is thermally stable.

20. A nonwoven fabric according to claim 1 wherein the nonwoven fabric is a filter material.

21. A nonwoven fabric according to claim 20 wherein the nonwoven fabric is an air filter.

22. A nonwoven fabric according to claim 20 wherein the nonwoven fabric is a water filter.

23. A nonwoven fabric according to claim 20 wherein the nonwoven fabric comprises a filter medium.

24. A nonwoven fabric according to claim 1 wherein the nonwoven fabric has a pore size distribution that is substantially uniform.

25. A nonwoven fabric according to claim 1 wherein the nonwoven fabric is a plant germination mat and wherein a plurality of seeds may be situated on or incorporated into the mat.

26. A nonwoven fabric according to claim 25 wherein the seeds are selected from flowering plant seeds, vegetable seeds and/or grass seeds.

27. A nonwoven fabric according to claim 25 wherein fertiliser and/or fungicide is also incorporated into the mat.

28. (Canceled)

29. A nonwoven fabric according to claim 1 wherein the nonwoven fabric is configured to facilitate the slow or sustained release of one or more medicaments.

30. A nonwoven fabric according to claim 29 wherein the nonwoven fabric is an absorbent article.

31. A nonwoven fabric according to claim 30 wherein the absorbent article is a wound dressing.

32. A nonwoven fabric according to claim 1 wherein the nonwoven fabric is configured as a cleansing article.

33. A nonwoven fabric according to claim 32 wherein the cleansing article is a wipe, pad and/or mop.

34. A nonwoven fabric according to claim 32 wherein the nonwoven fabric is impregnated with a detergent, bleach and/or wax.

35. (Canceled)

36. (Canceled)

37. A nonwoven fabric according to claim 1 wherein the weight of the fabric is in the range from about 20 to 1000 g/m² and fabric density is at least about 0.02 g/cm³.

38. A nonwoven fabric according to claim 1 wherein the density of the fabric is at least about 0.02 g/cm³.

39. A method of forming a nonwoven fabric comprising:
mixing about 0-15% w/w of thermoplastic fibres with waste materials in an air laying system.

40. A method according to claim 39 further comprising:
using a bonding device for the fibres that comprises a hydro-entanglement system and/or a thermal bonding system.

41. (Canceled)

42. A method of growing plants, comprising:
providing a plant germination mat that comprises:
fibres in which at least a portion of the fibres have a length from about 0.1 to 12 mm; and
binder for the fibres at a proportion of 15% w/w or less;
placing plant seeds onto the plant germination mat;
placing the plant germination mat on soil; and
watering the plant germination mat.

43. A method of cleaning a surface, comprising:
providing a cleansing article that comprises:
fibres in which at least a portion of the fibres have a length from about 0.1 to 12 mm; and
binder for the fibres at a proportion of 15% w/w or less;
using the cleansing article to clean the surface.
